(19) United States
(12) Patent Application Publication
(10) Pub. No.: US 2002/0112043 A1
(43) Pub. Date: Aug. 15, 2002

(54) Method and apparatus for storage on demand service

(76) Inventors: Akira Kagami, Los Gatos, CA (US); Akira Yamamoto, Cupertino, CA (US); Masayuki Yamamoto, Sunnyvale, CA (US)

Correspondence Address: SQUIRE, SANDERS & DEMPSEY L.L.P, 600 HANSEN WAY, PALO ALTO, CA, 94304-1043, US

(21) Appl. No.: 09/783,163

(22) Filed: Feb. 13, 2001

(51) Int. Cl. G06F 15/173

(52) U.S. Cl. 709/223

(57) ABSTRACT

The present invention provides improved techniques for managing storage resources, such as disk drives, I/O ports, and the like according to user demand for these storage resources. In a specific embodiment, a centralized SoD system that remotely activates installed storage resources in a storage subsystem on demand obviates the need to visit a particular site. Specific embodiments provide users the capability to bring new resources on line, define pathways between resources, and the like, for example. Embodiments can obviate the need for system programmers to manually configure storage resources on a user's site.

### BACKGROUND OF THE INVENTION

The present invention relates generally to techniques for managing storage resources, and in particular to techniques for providing storage on demand management services.

The information technology revolution brings with it an ever increasing need for more storage capacity for business enterprises. It is expected that the average Fortune 1000 company's storage requirement will more than double in the coming years. In addition, growth has brought shortages of skilled persons in the information technology field. These challenges confront many companies facing the need to expand and improve their information technology assets. Increasingly, companies are turning to outsourcing storage management as a method of coping with the need to grow capacity in view of rapidly increasing demand. Storage on Demand (SoD) is one such service for providing storage management to business enterprises. By subscribing to an SoD service, companies can obtain needed storage resources by purchasing the services of the SoD service provider. Typical resources available through SoD service providers may include capacity (storage devices), I/O ports, and the like.

While certain advantages to present SoD technologies are perceived, opportunities for further improvement exist. For example, according to conventional SoD technology, an SoD service provider must visit customer's sites to configure the customer's host computer installation to work with the SoD's storage resources. This can be a relatively time-consuming and costly process, especially in a situation where a substantial number of resources are managed. Further, the managing of storage resources is often an on-going task that is conventionally performed by a host computer that uses the storage resources. In other words, using conventional approaches, the SoD provider must visit the customer's site to perform necessary operations on the host computer even after introducing a centralized SoD system.

What is needed are improved techniques for managing storage resources according to user demand.

### SUMMARY OF THE INVENTION

The present invention provides improved techniques for managing storage resources, such as disk drives, I/O ports, and the like according to user demand for these storage resources. In a specific embodiment, a centralized SoD system that remotely activates installed storage resources in a storage subsystem on demand obviates the need to visit a particular site. Specific embodiments provide users the capability to bring new resources on line, define pathways between resources, and the like, for example. Embodiments employ a software agent that obviates the need for system programmers to manually configure storage resources on a user's site.

In a representative embodiment according to the present invention, an SoD service system is provided. The SoD service system comprises an SoD center system that is connected with a storage subsystem and a host computer via a communications network. A software agent that resides in the host computer provides a bridge between the SoD center system and the host computer's operating system. The SoD center system receives input of an SoD demand, and sends the demand to an SoD resource manager, which manages storage resources of the storage subsystem. The SoD resource manager receives the demand from the SoD center system, and updates a device management table and an I/O port management table. The current status of the storage resources is recorded in the device management and I/O port management tables, so that the SoD resource manager can refer to these tables when performing resource management operations. The SoD resource manager sends a management result to the SoD center system. The SoD center system receives the management result from the SoD resource manager, and stores the management result locally. In a specific embodiment, the management result is a return code. For example, the resource manager responds with an “OK” or “Completed” when the SoD demand is met. Otherwise, the resource “Not Completed” if the SoD demand is not met. The management result may include information about how the demand is realized, such as data from a device management table and an I/O port management table.

If the demand for storage resources requires that the I/O path setting be updated, the SoD center system sends an I/O path setting request to the SoD agent, which is embodied as a program running under the operating system in the host computer. The SoD agent provides the appropriate requests to the operating system to update an I/O path setting table in order to comply with the setting request. The SoD agent receives an update result from the operating system, and sends a setting result to the SoD center system. The form of the requests made to the operating system is determined by the particular operating system, and is well known to those of ordinary skill in the art. The SoD center system receives the setting result from the SoD agent, and stores the setting result locally. In a specific embodiment, the setting result is a return code. However, in select embodiments, the setting result may include information about how the demand has been realized, such as data from an I/O path setting table, for example.

In another representative embodiment according to the present invention, a storage apparatus is provided. Specific embodiments of the storage apparatus are especially useful in storage on demand applications. However, the present invention is not limited to storage on demand applications. The storage apparatus comprises a memory and one or more devices that store information. In specific embodiments, the one or more devices that store information comprise one or more of a magnetic disk, an optical disk, a magnetic-optical disk, and a semiconductor memory. The storage apparatus also includes one or more I/O ports that provide an interface to the one or more devices that store information, a device management table, in which a status of the one or more devices that store information is stored, and an I/O port management table, in which a status of the one or more I/O ports is stored. The device management table and the I/O port management table are disposed in the memory. The apparatus also comprises a storage management processor. The storage management processor receives a demand for storage resources, and updates the device management table and the I/O port management table, accordingly. The storage management processor also sends a management result responsive to the demand for storage resources. Further, updates to one or more paths connecting to storage resources allocated from the one or more devices that store information are automatically defined to an operating system of a user machine by a remotable software agent. In a specific embodiment, the apparatus further comprises a communications interface to a network. The storage management processor receives the demand for storage resources over the network.

In a further representative embodiment according to the present invention, a method for configuring a host computer to access resources in a remotable storage subsystem is provided. The host computer, the remotable storage subsystem, and a center system computer are interconnected by a communication network. The method comprises receiving at the host computer an I/O path setting request from the center system computer. The I/O path setting request comprises information about resources in the various components of the storage on demand system that make up a path to storage allocated for use by the host computer. In a specific embodiment, the resources, such as host I/O controllers in the host computer and I/O ports in the remotable storage subsystem, are assigned unique identifiers, analogous to world wide names (WWN) used in fibre channel networks, for example. The I/O setting request includes the unique identifiers of allocated resources in the storage on demand system that exist along a path to be set up in order for the host computer to access the storage resources. Requesting an operating system that is resident in the host computer to update an I/O path setting table based upon the I/O path setting request and receiving an update result from the operating system are also part of the method. In a specific embodiment, the update result is a return code. However, in select embodiments, the update result may include information about how the I/O path setting request has been realized, such as data from an I/O path setting table, for example. Updating the I/O path setting table comprises storing an indication that a particular I/O port in the storage subsystem is accessible to a particular host I/O controller. The method also includes sending a setting result to the center system computer based upon the update result. In a specific embodiment, the setting result is a return code. The setting result can be equivalent to the update result, or may be a return code based upon the update result. In select embodiments, the setting result may include information about how the I/O path setting request has been realized, such as data from an I/O path setting table, for example.

In a specific embodiment, the method further comprises receiving at the center system computer an input of a demand for storage resources. Determining whether sufficient resources exist in order to meet the demand is also part of the method. If there are sufficient resources, then the demand for storage resources is sent to the storage subsystem. The method also includes receiving from the storage subsystem a management result, which indicates whether storage resources have been successfully allocated in accordance with the demand. The management result may be a return code, such as an “OK” or a “Completed” when the SoD demand is met, a “NG” or a “Not Completed” if the SoD demand is not met. The management result may include information about how the demand is realized, such as data from a device management table and an I/O port management table.

The management result is stored. Further, the method includes determining whether the demand includes an I/O path setting request, and if so, sending the I/O path setting request to the host computer. Receiving the setting result from the host computer and storing the setting result are also part of the method.

In another specific embodiment, the method further comprises receiving the demand for storage resources at the storage subsystem. Determining whether the demand includes a command to make one or more installed devices available is also part of the method. If the demand includes a command to make one or more installed devices available, then a device management table is updated. Updating the device management table comprises storing an indication that a particular device is usable into the device management table. The method also includes updating an I/O port management table and sending a resource management result to the center computer system. Updating the I/O port management table comprises storing an indication that a particular I/O port is usable into the I/O port management table.

In a further specific embodiment, the method further comprises receiving an I/O command to access storage resources at the storage subsystem from the host computer. Determining whether storage resources requested by the I/O command are usable is also part of the method. If the storage resources requested by the I/O command are usable, then the I/O command is performed. Otherwise, the I/O command is rejected. Determining whether storage resources requested by the I/O command are usable includes searching the device management table to determine whether devices requested in the I/O command are usable. Further, determining whether storage resources requested by the I/O command are usable can also include searching the I/O port management table to determine whether I/O ports requested in the I/O command are usable and whether devices requested in the I/O command are accessible via I/O ports requested in the I/O command. The method further includes sending an I/O result to the host computer.

In a still further representative embodiment according to the present invention, a computer program product for configuring a host computer to access resources in a remotable storage subsystem is provided. The host computer, the remotable storage subsystem, and a center system computer are interconnected by a communication network. The computer program product comprises code at the host computer that receives an I/O path setting request from the center system computer. The I/O path setting request comprises information about resources in the remotable storage subsystem allocated for use by the host computer. Code that requests an operating system resident in the host computer to update an I/O path setting table based upon the I/O path setting request and code that receives an update result from the operating system is also part of the computer program product. Further, the program product includes code that sends a setting result to the center system computer based upon the update result. The program product also includes a computer readable storage medium for holding the codes.

In a specific embodiment, the computer program product further comprises code at the center system computer that receives an input of a demand for storage resources. Code that determines whether sufficient resources exist in order to meet the demand is also part of the computer program product. The computer program product also includes code that sends the demand for storage resources to the storage subsystem, if sufficient resources are determined to exist. Code that receives a management result from the storage subsystem and code that stores the management result are also included in the computer program product. The management result indicates whether storage resources have been successfully allocated in accordance with the demand. The program product also includes code that determines whether the demand includes an I/O path setting request and code that sends the I/O path setting request to the host computer, if the demand includes an I/O path setting request. Further, code that receives the setting result from the host computer and code that stores the setting result are part of the computer program.

Numerous benefits are achieved by way of the present invention over conventional techniques. Specific embodiments provide users with the capability to bring new resources on line, define pathways between resources, and the like, for example. Embodiments can obviate the need for system programmers from an SoD service provider to manually configure storage resources on a user's site. Specific embodiments can provide storage resources to users at reduced cost.

These and other benefits are described throughout the present specification. A further understanding of the nature and advantages of the invention herein may be realized by reference to the remaining portions of the specification and the attached drawings.

### BRIEF DESCRIPTION OF THE DRAWINGS

FIG. 1 illustrates a diagram of a representative system for embodying a centralized SoD service in a specific embodiment according to the present invention.

FIG. 2 illustrates a representative device management table in a specific embodiment according to the present invention.

FIG. 3 illustrates a representative I/O port management table in a specific embodiment according to the present invention.

FIG. 4 illustrates a representative I/O path setting table in a specific embodiment according to the present invention.

FIG. 5 illustrates a flowchart of representative SoD center processing in a specific embodiment according to the present invention.

FIG. 6 illustrates a flowchart of representative SoD service module center processing in a specific embodiment according to the present invention.

FIG. 7 illustrates a flowchart of representative SoD resource manager processing in a specific embodiment according to the present invention.

FIG. 8 illustrates a flowchart of representative SoD resource manager processing in a specific embodiment according to the present invention.

FIG. 9 illustrates a flowchart of representative SoD agent processing in a specific embodiment according to the present invention.

FIG. 10 illustrates an example of a graphical user interface (GUI) for receiving input of an SoD demand to the SoD center system in a specific embodiment according to the present invention.

FIG. 11 illustrates the representative I/O port management table in a specific embodiment according to the present invention.

FIG. 12 illustrates the representative I/O path setting table in a specific embodiment according to the present invention.

FIG. 13 illustrates an example of a graphical user interface (GUI) for receiving input of an SoD demand to the SoD center system in a specific embodiment according to the present invention.

FIG. 14 illustrates a representative device management table in a specific embodiment according to the present invention.

FIG. 15 illustrates the representative I/O port management table in a specific embodiment according to the present invention.

FIG. 16 illustrates the representative I/O path setting table in a specific embodiment according to the present invention.

FIG. 17 illustrates an example system architecture employing a switching network in a specific embodiment according to the present invention.

### DESCRIPTION OF THE SPECIFIC EMBODIMENTS

The present invention provides improved techniques for managing storage resources, such as disk drives, I/O ports, and the like according to user demand for storage. Specific embodiments provide users the capability to bring new resources on line, define pathways between resources, and the like. Embodiments can obviate the need for system programmers to manually configure storage resources on a user's site.

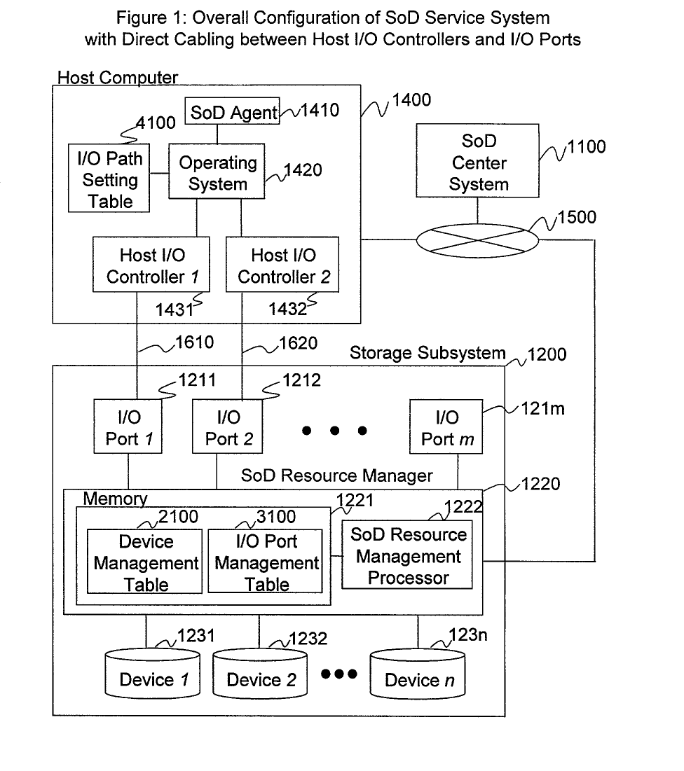

FIG. 1 illustrates a diagram of a representative system for providing centralized SoD service in a specific embodiment according to the present invention. In FIG. 1, the SoD service system is comprised of an SoD center system 1100 coupled via a communications network 1500 to a storage subsystem 1200 and host computer 1400. In the specific embodiment illustrated by FIG. 1, the host computer 1400 and the storage subsystem 1200 are connected by lines 1610 and 1620, which connect host I/O controller 1 (1431) and host I/O controller 2 (1432) of the host computer 1400 to I/O port 1 (1211) and I/O port 2 (1212) of the storage subsystem 1200, respectively.

The SoD center system 1100 comprises a computer connected to an input device, an output device, a storage device, and a communications link that connects SoD center system 1100 to the network 1500. In a representative embodiment, the input device is at least one of a keyboard, a mouse, a touch screen, or a track ball. The output device is a display. The storage device may be a magnetic disk, an optical disk, a magnetic-optical disk, or a semiconductor memory. The storage device has a storage capacity sufficient to store files for execution of programs, as well as data. In a presently preferred embodiment, the communications link is capable of high-speed communications. While one specific embodiment for realizing the SoD center system 1100 has been described, other embodiments having other and different hardware and software may be used to embody the SoD center system 1100 of the present invention.

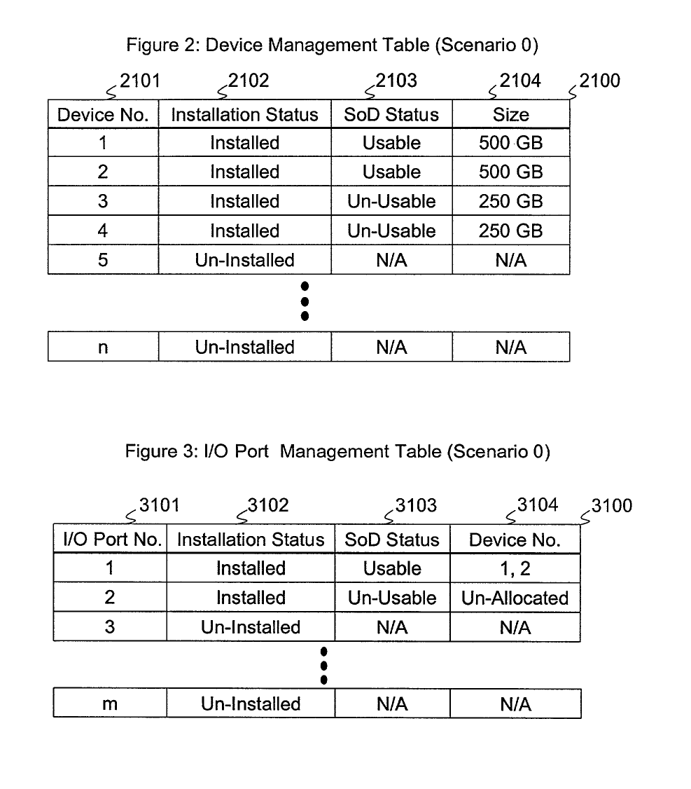

The storage subsystem 1200 comprises at least two I/O ports (1211 through 121m), one or more storage devices (1231 through 123n), and an SoD resource manager 1220, which manages storage resources in the storage subsystem 1200. The plurality of I/O ports 1211 through 121m provide connectivity to one or more host computers such as host computer 1400 via lines 1610 and 1620. The SoD resource manager 1220 comprises of an SoD resource management processor 1222 and a memory 1221. The I/O ports 1211 through 121 m are connected to the SoD resource manager 1220. Storage devices 1231 through 123n are also connected to the SoD resource manager 1220. Memory 1221 of SoD resource manager 1220 stores a device management table 2100 and an I/O port management table 3100, which are also shown in FIG. 2 and FIG. 3, respectively. A user may interact with the storage subsystem 1200 via any computer system as its host computer, such as host computer 1400, if the host computer has at least one port to communicate with the SoD center system 1100 and at least two host I/O controllers (1431 and 1432) which have physical connections (1610 and 1620) to some of the I/O ports (1211 through 121m) of the storage subsystem 1200.

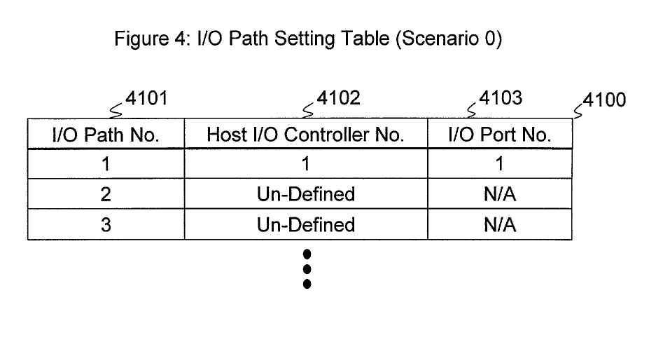

The host computer 1400 comprises an SoD agent 1410 operable in conjunction with an operating system 1420 and an I/O path setting table 4100. Operating system 1420 is operatively disposed to coordinate information flowing to and from host I/O controllers 1431 and 1432. Further, the operating system 1420 controls processing of system events within host computer 1400. The SoD agent 1410 runs under the operating system 1420 which controls the host I/O controllers (1431 and 1432) and I/O path setting table 4100. The SoD agent 1410 acts as a bridge between the SoD center system 1100 and the operating system 1420 by translating commands from the SoD center system 1100 into requests to the operating system 1420 to update I/O path setting table 4100 to reflect resource allocations made by the SoD resource manager 1220 in the storage subsystem 1200 on behalf of the users of the host computer 1400. The I/O path setting table 4100 is illustrated in greater detail in FIG. 4. FIG. 2 through FIG. 4 illustrate tables of data show an initial status, herein referred to as “Scenario 0,” of storage resources in a representative SoD system.

FIG. 2 illustrates a representative device management table in a specific embodiment according to the present invention. In FIG. 2, device management table 2100 comprises a plurality of columns, including a device number (2101), an installation status (2102), an SoD status (2103), and a size (2104). In the representative example embodiment illustrated by FIG. 2, entries exist for device number 1 (1231) through device number n (123n), but only device number 1 (1231) through device number 4 (1234) are installed. Further, only device number 1 (1231) and device number 2 (1232) are usable as currently configured in FIG. 2. Thus, in the example configuration illustrated by table 2100 of FIG. 2, a total of 1 TB of storage is available, comprising 500 GB residing on device number 1(1231) and 500 GB residing on device number 2 (1232).

FIG. 3 illustrates a representative I/O port management table in a specific embodiment according to the present invention. In FIG. 3, the I/O port management table 3100 comprises a plurality of columns, including I/O port number (3101), an installation status (3102), an SoD status (3103), and a device number (3104). In the representative example illustrated by FIG. 3, entries exist for I/O port number 1 (1211) through I/O port number m (121m), but only I/O port number 1 (1211) and I/O port number 2 (1212) are installed. However, as currently configured in FIG. 3, only I/O port number 1 (1211) which connects device number 1 (1231) is available.

FIG. 4 illustrates a representative I/O path setting table in a specific embodiment according to the present invention. FIG. 4 illustrates I/O path setting table 4100, which comprises a plurality of columns, including an I/O path number (4101), a host I/O controller number (4102), and an I/O port number (4103). As illustrated by the representative example of FIG. 4, I/O path number 1 is defined. The defined path provides a connection from the host computer 1400 to device number 1 (1231) through host I/O controller number 1 (1431) and I/O port number 1 (1211). It is noteworthy that host I/O controller 2 (1432) is “physically” connected to I/O port 2 (1212) by line 1620 as shown in FIG. 1. However, the I/O port number 2 (1212) is not enabled for use in the representative example illustrated by FIG. 4.

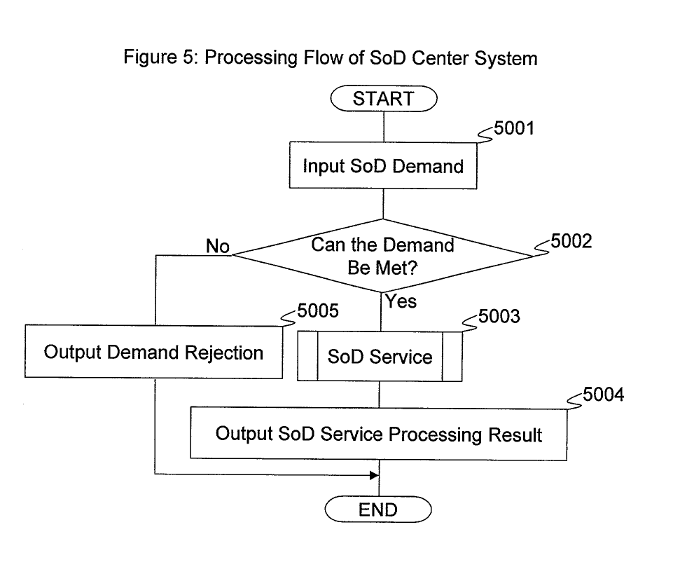

FIG. 5 illustrates a flowchart of representative SoD center system processing in a specific embodiment according to the present invention. In FIG. 5, the SoD center system 1100 inputs an SoD demand in a step 5001. In a decisional step 5002, it is determined whether the demand can be met. If the demand can be met, then the SoD center system 1100 performs SoD service processing in a step 5003 and outputs an SoD service processing result in a step 5004. Otherwise, the SoD center system 1100 outputs a demand rejection in a step 5005.

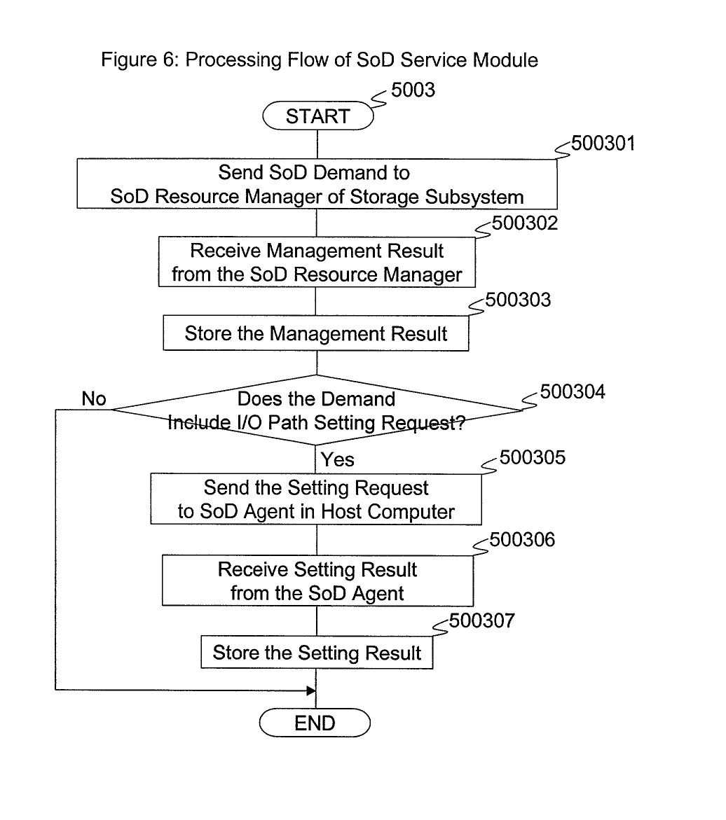

FIG. 6 illustrates a flowchart of representative SoD service module processing in an SoD center system in a specific embodiment according to the present invention. In FIG. 6, the SoD center system 1100 sends the demand to SoD resource manager 1220 of storage subsystem 1200 in a step 500301, and receives a management result from the SoD resource manager 1220 in a step 500302. The SoD center system 1100 stores the result in a step 500303. In a decisional step 500304, it is determined whether the demand includes an I/O path setting request. If the demand does not include an I/O path setting request, then the SoD center system 1100 skips the remainder of the processing of FIG. 6. Otherwise, the SoD center system 1100 sends the setting request to the SoD agent 1410 in the host computer 1400 connected to the storage subsystem 1200 in a step 500305. The I/O path setting request comprises information about resources in the various components of the storage on demand system that comprise a path between the host computer 1400 and storage resources allocated in storage subsystem 1200. In a specific embodiment, the resources, such as host I/O controllers in the host computer and I/O ports in the remotable storage subsystem, are assigned unique identifiers, analogous to world wide names (WWN) used in fibre channel networks, for example. The I/O setting request includes the unique identifiers of the resources in the storage on demand system that exist along the path to be set in order for users at the host computer 1400 to access the storage resources in the storage subsystem 1200. Then, the SoD center system 1100 receives the setting result from the agent 1410 in a step 500306. The SoD center system 1100 stores the result in a step 500307 and completes the processing of FIG. 6.

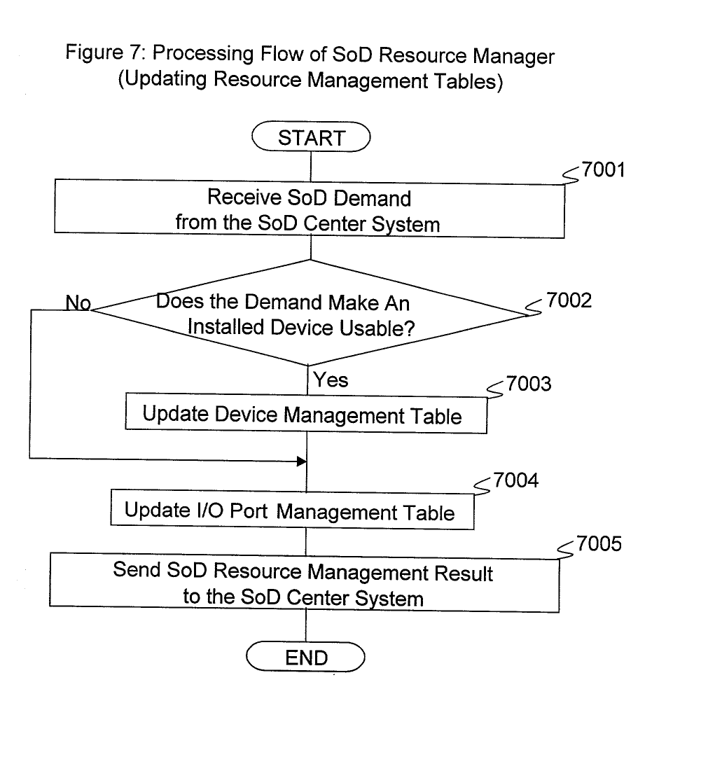

FIG. 7 illustrates a flowchart of representative SoD resource manager processing in a specific embodiment according to the present invention. In FIG. 7, the SoD resource manager 1220 receives the SoD demand from the SoD center system 1100 in a step 7001. In a decisional step 7002, it is determined whether the demand includes a command to the SoD resource manager 1220 to make an installed device usable. If the demand includes the command to make an installed device usable, then the SoD resource manager 1220 updates the device management table 2100 in a step 7003, updates the I/O port management table 3100 in a step 7004, and sends an SoD resource management result to the SoD center system in a step 7005. Otherwise, if in step 7002, it is determined that the demand does not include a command to make an installed device usable, the SoD resource manager 1220 skips the step 7003, and continues processing with step 7004.

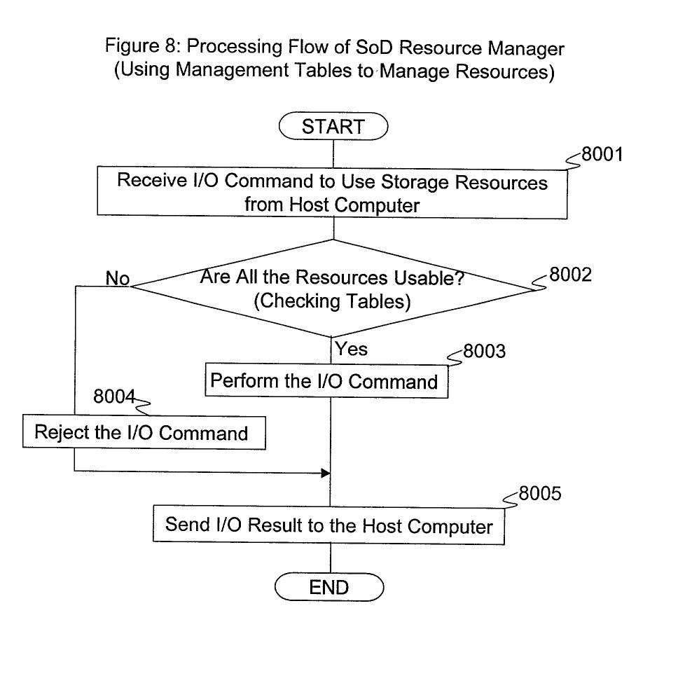

FIG. 8 illustrates a flowchart of representative SoD resource manager processing for a storage access request in a specific embodiment according to the present invention. The SoD resource manager 1220 manages storage resources and I/O ports in the storage subsystem 1200. In FIG. 8, the SoD resource manager 1220 receives an I/O command to use storage resources from the host computer 1400 in a step 8001. In a decisional step 8002, the SoD resource manager checks the tables 2100 and 3100 to see if the resources are currently available. If in step 8002, it is determined that the resources are available, then the SoD resource manager performs the I/O command in a step 8003. Then, the SoD resource manager sends an I/O result to the host computer 1400 in a step 8005. Otherwise, if in step 8002, it is determined that any of the resources are not available, the SoD resource manager 1220 rejects the I/O command in a step 8004, skips step 8003, and sends the result back to host computer 1400 in step 8005. In a specific embodiment, the I/O result is a return code. However, in select embodiments, the I/O result can comprise the information read from the disk when the I/O command has successfully executed.

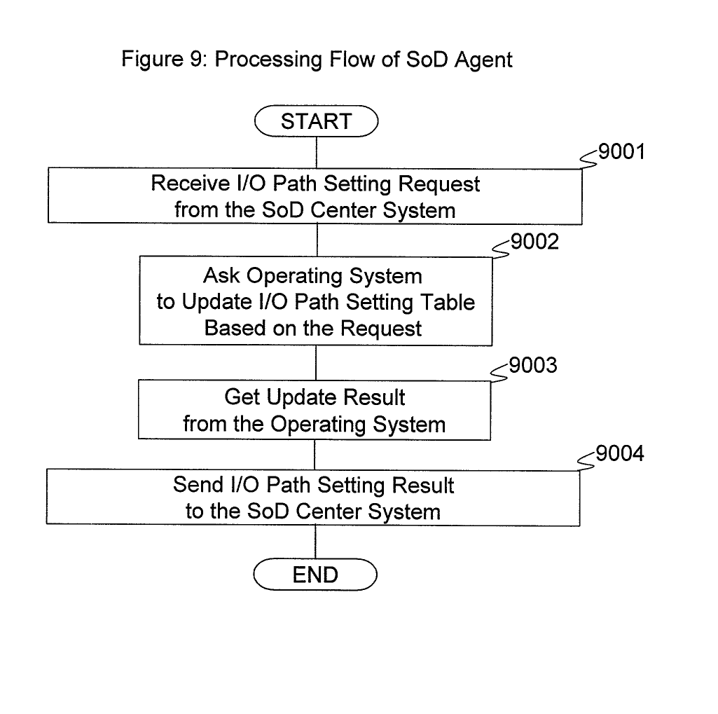

FIG. 9 illustrates a flowchart of representative SoD agent processing in a specific embodiment according to the present invention. In FIG. 9, the SoD agent 1410 receives an I/O path setting request from the SoD center system 1100 in a step 9001. Then, the SoD agent requests that the operating system 1420 update the I/O path setting table 4100 based upon the I/O path setting request in a step 9002. The SoD agent 1410 takes the unique identifier or identifiers corresponding to resources along the path to be established and formats requests to the operating system to set up the appropriate paths. The operating system 1420 may be any of a variety of operating systems, such as OS/390, UNIX, and Windows, which have the function of setting and controlling I/O paths. The formatting of the I/O setting request will be unique to the particular operating system 1420, and will be readily apparent to those of ordinary skill in the art. The SoD agent 1410 receives an update result from the operating system 1420 in a step 9003. Then, the SoD agent sends a setting result to the SoD center system 1100 in a step 9004.

The present invention will now be described with reference to particular example operations conducted in specific embodiments.

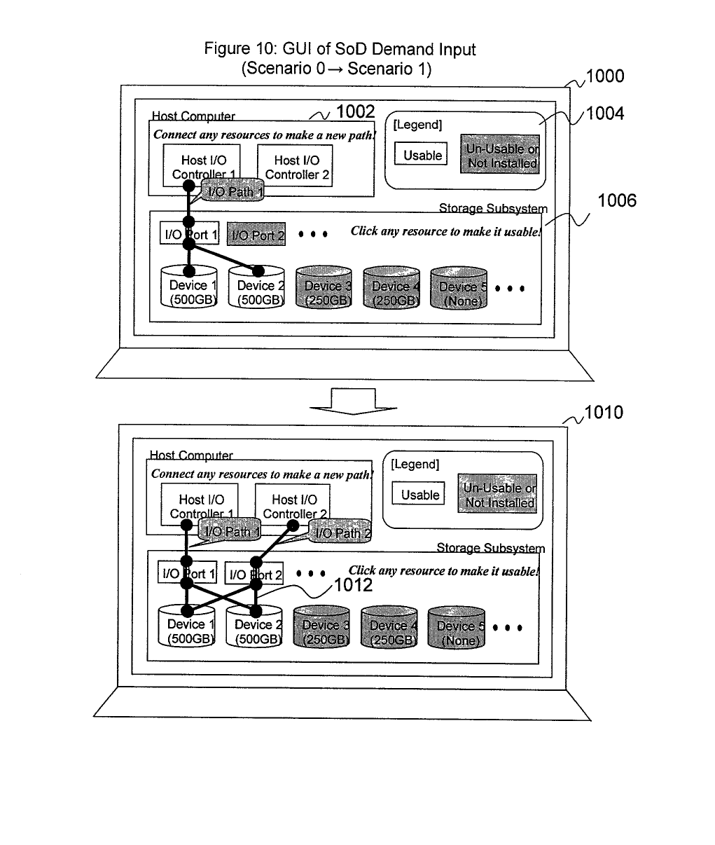

FIG. 10 illustrates an example of a graphical user interface (GUI) for receiving input of an SoD demand to the SoD center system 1100 in a specific embodiment according to the present invention. FIG. 10 illustrates a first representative user interface screen 1000, having a host computer panel 1002, which comprises icons for each host I/O controller known to the system, such as host I/O controller number 1 (1431) and host I/O controller 2 (1432). A legend panel 1004 provides information useful to the user, such as indications used in the other panels and their associated meanings. A storage subsystem panel 1006 provides information about the storage subsystem 1200 in the SoD center system 1100. Storage subsystem panel 1006 comprises a plurality of icons, including icons corresponding to the I/O port number 1 (1211), I/O port number 2 (1212), and the like, as well as icons corresponding to storage devices, such as device number 1 (1231), device number 2 (1232), and so forth.

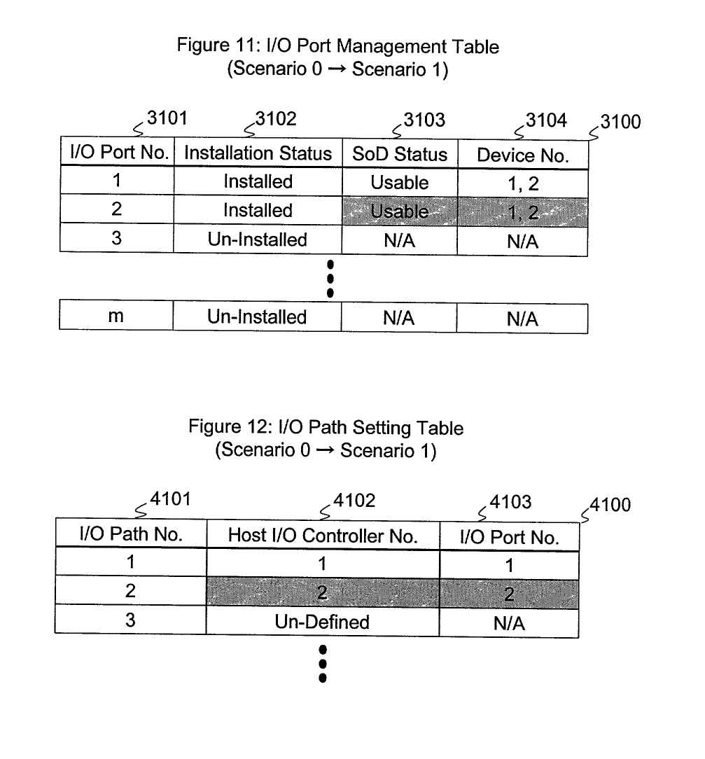

FIG. 10 illustrates a second representative user interface screen 1010, corresponding to a situation, herein referred to as scenario 1, where another channel, I/O port number 2 (1212), which has been installed but not made usable, is demanded through host I/O controller 2 (1432). This may occur as a result of a user who desires greater bandwidth between the host computer 1400 and the devices of the storage subsystem 1200, for example. The user configures the system using the user interface screen 1010 by first making I/O port number 2 (1212) usable. The user clicks a shaded icon for a resource to make it usable. Once the user has clicked the icon corresponding to the I/O port number 2 (1212), the icon is depicted in a color or other indication that shows that the corresponding device is now usable. Next, the user establishes a connection between resources by drawing a connecting line between two or more resources to create a new I/O path. In the user interface screen 1010, the user has established a second I/O path 1012 defined from host I/O controller 2 (1432) to device number 1 (1231) and device number 2 (1232) via I/O port number 2 (1212). Based upon the inputs of the user, the SoD resource manager 1220 updates the I/O port management table 3100 while the SoD agent 1410 requests the operating system 1420 to update the I/O path setting table 4100, as shown by FIG. 11 and FIG. 12, respectively.

FIG. 11 illustrates the representative I/O port management table in a specific embodiment according to the present invention. In the representative example I/O path management table illustrated by FIG. 3, I/O port number 1 (1211) and I/O port number 2 (1212) were installed. However, as illustrated in FIG. 3, I/O port number 1 (1211), which connects to device number 1 (1231) was made available, while I/O port number 2 (1212) was not made available. By contrast, in the I/O port management table 3100 illustrated in FIG. 11, both I/O port number 1 (1211) and I/O port number 2 (1212) are installed and available. This second I/O port is made available as a result of the user's interaction with the user interface screen 1010 as illustrated by FIG. 10.

FIG. 12 illustrates the representative I/O path setting table in a specific embodiment according to the present invention. In the representative example I/O path setting table illustrated by FIG. 4, I/O path number 1 was defined. The defined path provides a connection from the host computer 1400 to device number 1 (1231) through host I/O controller number 1 (1431) and I/O port number 1 (1211). However, in FIG. 4, the I/O port number 2 (1212) was installed but was not enabled for use. By contrast, in the I/O setting table 4100 illustrated in FIG. 12, a second I/O path is defined. The second I/O path, I/O path number 2, provides a connection from the host I/O controller 2 (1432) to I/O port number 2 (1212). This second I/O path is defined as a result of the user's interaction with the user interface screen 1010 as illustrated by FIG. 10.

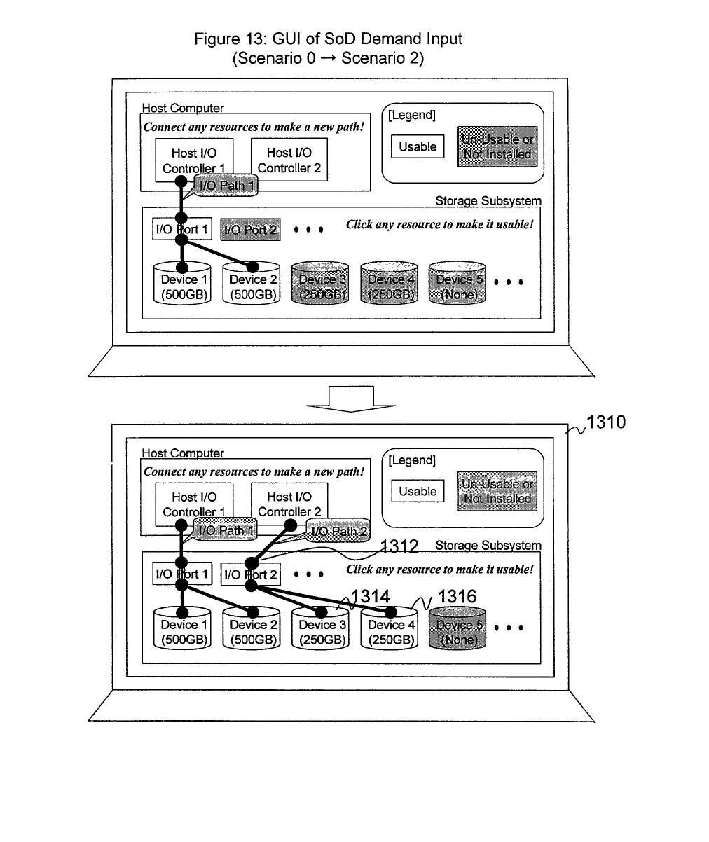

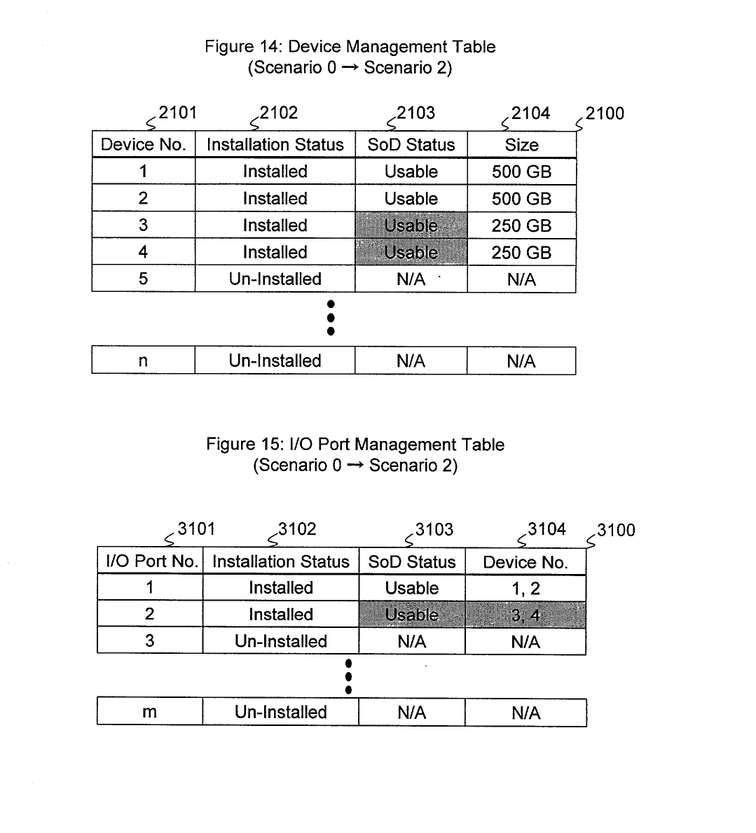

FIG. 13 illustrates the example of a graphical user interface (GUI) for receiving input of an SoD demand to the SoD center system 1100 in a specific embodiment according to the present invention. FIG. 13 illustrates a first representative user interface screen 1300, corresponding to scenario 0, which was also illustrated by user input screen 1000 in FIG. 10. FIG. 13 also illustrates a second representative user interface screen 1310, corresponding to scenario 2, a situation in which 500 GB more capacity is demanded through host I/O controller 2 (1432). This situation can arise if, for example, the computer user desires to make sufficient storage available for another application without giving an extra burden on the I/O path 1 which the existing application is currently using. The user selects installed device number 3 (1233) and device number 4 (1234) by clicking corresponding icons 1314 and 1316 of the user interface screen 1310 with the mouse or other pointing device. The SoD system will respond by making these resources available, as will be discussed in further detail with respect to FIG. 14. Once the user has clicked the icons corresponding to the device number 3 (1233) and device number 4 (1234), the icons are depicted in a color or other indication that shows that the corresponding device is now usable. Next, the user establishes a connection between resources by drawing a connecting line between two or more resources to create a new I/O path. In the user interface screen 1310, the user has established a second I/O path 1312 defined from host I/O controller 2 (1432) to device number 3 (1233) and device number 4 (1234) via I/O port number 2 (1212).

FIG. 14 illustrates a representative device management table in a specific embodiment according to the present invention. In the representative example device management table illustrated by FIG. 2, a total of 1 TB of storage was available, comprising 500 GB residing on device number 1(1231) and 500 GB residing on device number 2 (1232). By contrast, in the device management table 2100 illustrated in FIG. 14, device 3 (1233) is made usable, providing an additional 250 GB of storage, and device 4 (1234) is made usable, providing another additional 250 GB of storage. The SoD system makes these devices usable in accordance with the selections of the user discussed above with respect to FIG. 13.

FIG. 15 illustrates the representative I/O port management table in a specific embodiment according to the present invention. In the representative example I/O path management table illustrated by FIG. 3, I/O port number 1 (1211) and I/O port number 2 (1212) were installed. However, as illustrated in FIG. 3, I/O port number 1 (1211), which connects device number 1 (1231) was made available, while I/O port number 2 (1212) was not made available. By contrast, in the I/O port management table 3100 illustrated in FIG. 15, both I/O port number 1 (1211) and I/O port number 2 (1212) are installed and available. Further, I/O port number 2 (1212) is operable with device 3 (1233) and device 4 (1234). This second I/O port is made available as a result of the user's inputs using the user interface screen 1310 as illustrated by FIG. 13.

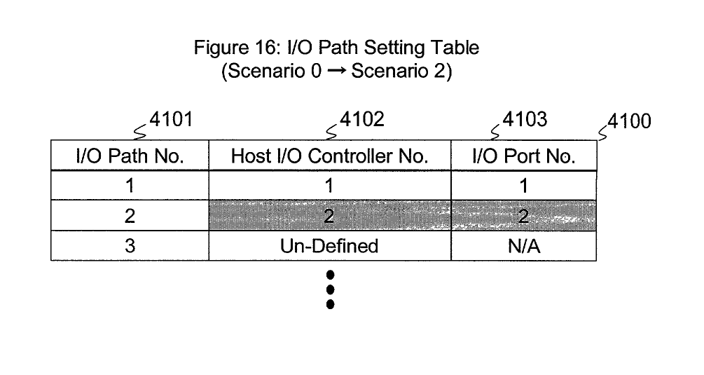

FIG. 16 illustrates the representative I/O path setting table in a specific embodiment according to the present invention. In the representative example I/O path setting table illustrated by FIG. 4, I/O path number 1 was defined. The defined path provides a connection from the host computer 1400 to device number 1 (1231) through host I/O controller number 1 (1431) and I/O port number 1 (1211). However, in FIG. 4, the I/O port number 2 (1212) was installed but was not enabled for use. By contrast, in the I/O setting table 4100 illustrated in FIG. 16, a second path is defined. The second I/O path number 2 provides a connection from the host I/O controller 2 (1432) to I/O port number 2 (1212). This second I/O path is defined as a result of the user's interaction with the user interface screen 1310 as illustrated by FIG. 13.

While the present invention has been generally described using as examples specific embodiments employing a single host computer and a single storage subsystem which are physically connected to each other with direct connections, the present invention is not nearly so limited. In fact, specific embodiments of the present invention can comprise one or more host computers interconnected to one or more storage subsystems by one or more logical connections, such as by using a fibre channel switch, for example. In such specific embodiments, logical connections between the host I/O controllers and the I/O ports can be made virtually at any time. This eliminates much of the need to plan the cabling of I/O controllers and I/O ports when the SoD system is introduced.

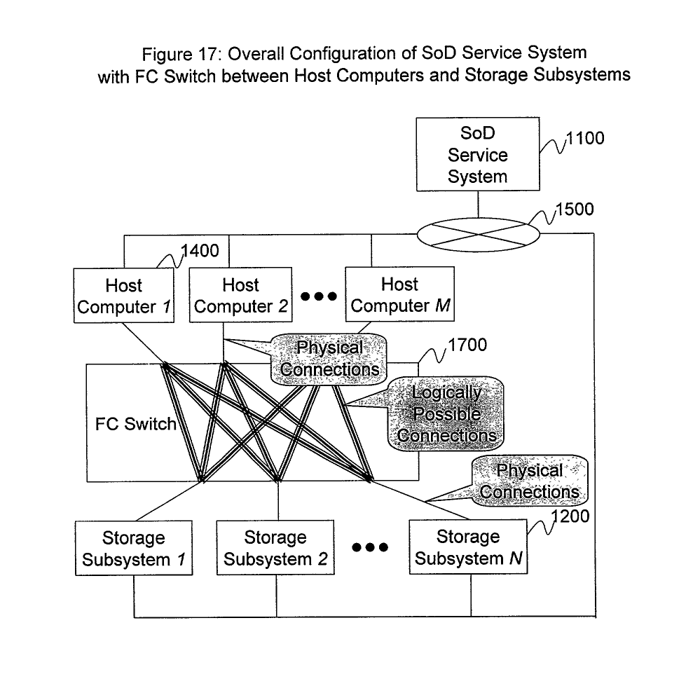

FIG. 17 illustrates an example system architecture employing a switching network in a specific embodiment according to the present invention. As illustrated in FIG. 17, the embodiments of the present invention using a switching network 1700, such as a fibre channel (ICC) switch, for example, are capable of connecting multiple host computers, such as host computer 1400, with multiple storage subsystems, such as storage subsystem 1200, without substantial change of the processing described above. In a fibre channel protocol, each device, i.e., servers, switches, disk systems, and so forth, attached to the fibre channel is identified by a unique world wide name (WWN). Further, each logical volume in the storage subsystem is identified by the port ID, or disk interface port ID, and a logical unit number (LUN). One advantage of embodiments employing fibre channel switching is that logically possible connections in the fibre switch 1700 in FIG. 17, between the host I/O controllers and the I/O ports that physically connect to the switch 1700 at any time without the necessity of re-cabling. Further, in specific embodiments, the multiple host computers and the multiple storage subsystems can be located at different sites.

The preceding has been a description of the preferred embodiment of the invention. It will be appreciated that deviations and modifications can be made without departing from the scope of the invention, which is defined by the appended claims.

What is claimed is:

1. A storage management service system, comprising:
a storage on demand (SoD) center system computer;
a storage subsystem; and
a host computer, said host computer, said storage subsystem, and said SoD center system computer interconnected by a communications network; said host computer comprising a software agent, said software agent providing an interface between said SoD center system computer and an operating system resident on said host computer; and wherein
said SoD center system computer receives input of an SoD demand, sends said demand to an SoD resource manager, which manages storage resources of said storage subsystem; and wherein said SoD resource manager receives said demand from said SoD center system computer, and thereupon updates a device management table and an I/O port management table, in which a current status of at least one of a plurality of resources is recorded, and to which said SoD resource manager refers when managing said at least one of a plurality of resources, and sends a management result to the SoD center system computer; and wherein
said SoD center system computer receives said management result from said SoD resource manager, and thereupon stores said management result.

2. The system of claim 1, wherein if said demand requires an I/O path setting to be updated, said SoD center system computer sends an I/O path setting request to said software agent running in said host computer; and wherein said software agent receives said I/O path setting request from said SOD center system computer, and thereupon requests said operating system to update an I/O path setting table based upon said I/O path setting request, and receives an update result from said operating system, and thereupon sends a setting result to said SoD center system computer, and wherein said SoD center system computer receives said setting result from said software agent, and thereupon stores said setting result.

3. The system of claim 1, wherein said host computer and said storage subsystem are connected directly by physical and logical connections made between at least one of a plurality of host I/O controllers and at least one of a plurality of subsystem I/O ports.

4. The system of claim 1, wherein said host computer and said storage subsystem are connected by a network switch between at least one of a plurality of host I/O controllers and at least one of a plurality of subsystem I/O ports.

5. The system of claim 4, wherein said network switch comprises a fibre channel network switch.

6. A storage apparatus comprising:
a memory;
at least one of a plurality of devices that store information;
at least one of a plurality of I/O ports providing an interface to said at least one of a plurality of devices that store information;
a device management table, in which a status of said at least one of a plurality of devices that store information is stored, and an I/O port management table, in which a status of said at least one of a plurality of I/O ports is stored, said device management table and said I/O port management table being disposed in said memory; and
a storage resource management processor; wherein
said storage management processor receives a demand for storage resources, and thereupon updates said device management table and said I/O port management table, and sends a management result responsive to said demand for storage resources; and wherein updates to at least one of a plurality of paths connecting to storage resources allocated from said at least one of a plurality of devices that store information are automatically defined to an operating system of a user machine by a remotable software agent.

7. The apparatus of claim 6, said at least one of a plurality of devices that store information comprising at least one of magnetic disk, an optical disk, a magnetic-optical disk, and a semiconductor memory.

8. The apparatus of claim 6, further comprising a communications interface to a network, said storage management processor receiving said demand for storage resources over said network.

9. The apparatus of claim 6, further comprising a fibre channel switch, said fibre channel switch providing capability to connect to at least one of a plurality of host computers.

10. A method for configuring a host computer to access resources in a remotable storage subsystem, said host computer, said remotable storage subsystem, and a center system computer interconnected by a communication network, said method comprising:
receiving at said host computer an I/O path setting request from said center system computer, said I/O path setting request comprising information about resources in said remotable storage subsystem allocated for use by said host computer;
requesting an operating system resident in said host computer to update an I/O path setting table based upon said I/O path setting request;
receiving an update result from said operating system; and
sending a setting result to said center system computer based upon said update result.

11. The method of claim 10, wherein updating said I/O path setting table comprises: storing an indication that a particular I/O port in said storage subsystem is accessible to a particular host I/O controller.

12. The method of claim 10, further comprising:
receiving at said center system computer an input of a demand for storage resources;
determining whether sufficient resources exist in order to meet said demand;
sending said demand for storage resources to said storage subsystem, if sufficient resources were determined to exist;
receiving from said storage subsystem a management result, said management result indicating whether storage resources have been successfully allocated in accordance with said demand;
storing said management result;
determining whether said demand includes an I/O path setting request;
sending said I/O path setting request to said host computer, if said demand included an I/O path setting request;
receiving said setting result from said host computer; and
storing said setting result.

13. The method of claim 12, further comprising:
receiving said demand for storage resources at said storage subsystem;
determining whether said demand includes a command to make at least one of a plurality of installed devices available;
updating a device management table, if said demand includes a command to make at least one of a plurality of installed devices available;
updating an I/O port management table; and
sending a resource management result to said center computer system.

14. The method of claim 13, wherein updating a device management table comprises: storing an indication that a particular device is usable.

15. The method of claim 13, wherein updating a I/O port management table comprises: storing an indication that a particular I/O port is usable.

16. The method of claim 13, further comprising:
receiving at said storage subsystem an I/O command to access storage resources from said host computer;
determining whether storage resources requested by said I/O command are usable;
performing said I/O command, if said storage resources requested by said I/O command are usable, otherwise rejecting said I/O command; and
sending an I/O result to said host computer.

17. The method of claim 16, wherein determining whether storage resources requested by said I/O command are usable comprises:
searching said device management table to determine whether devices requested in said I/O command are usable.

18. The method of claim 17, wherein determining whether storage resources requested by said I/O command are usable further comprises:
searching said I/O port management table to determine whether I/O ports requested in said I/O command are usable and whether devices requested in said I/O command are accessible via I/O ports requested in said I/O command.

19. A computer program product for configuring a host computer to access resources in a remotable storage subsystem, said host computer, said remotable storage subsystem, and a center system computer interconnected by a communication network, said computer program product comprising:
code that receives at said host computer an I/O path setting request from said center system computer, said I/O path setting request comprising information about resources in said remotable storage subsystem allocated for use by said host computer;
code that requests an operating system resident in said host computer to update an I/O path setting table based upon said I/O path setting request;
code that receives an update result from said operating system;
code that sends a setting result to said center system computer based upon said update result; and
a computer readable storage medium for holding the codes.

20. The computer program product of claim 19, further comprising:
code that receives at said center system computer an input of a demand for storage resources;
code that determines whether sufficient resources exist in order to meet said demand;
code that sends said demand for storage resources to said storage subsystem, if sufficient resources are determined to exist;
code that receives from said storage subsystem a management result, said management result indicating whether storage resources have been successfully allocated in accordance with said demand;
code that stores said management result;
code that determines whether said demand includes an I/O path setting request;
code that sends said I/O path setting request to said host computer, if said demand includes an I/O path setting request;
code that receives said setting result from said host computer; and
code that stores said setting result.
